(19) United States
(12) Patent Application Publication
(10) Pub. No.: US 2014/0056565 A1
(43) Pub. Date: Feb. 27, 2014

(54) OPTICAL FIBER CABLE NETWORK AND METHOD OF CONSTRUCTION OF AN OPTICAL FIBER CABLE NETWORK

(71) Applicant: NEW MEDIA CO., LTD., Yonezawa-shi (JP)

(72) Inventors: Shigeyoshi Harada, Yonezawa-shi (JP); Teruaki Arashida, Niigata-shi (JP)

(73) Assignee: NEW MEDIA CO., LTD., Yonezawa-shi (JP)

(21) Appl. No.: 13/871,419

(22) Filed: Apr. 26, 2013

(30) Foreign Application Priority Data
Aug. 27, 2012 (JP) 2012-186336
Dec. 28, 2012 (JP) 2012-288330

(51) Int. Cl. G02B 6/44

(52) U.S. Cl. CPC G02B 6/4495; G02B 6/4479
USPC 385/100; 29/428

(57) ABSTRACT

An optical fiber cable network and method of construction of an optical fiber cable network. An optical fiber cable network 100 is provided with an optical fiber cable 10 which has a plurality of optical fiber cores 70a, 70b, and 71 which transmit an optical signal, an optical signal device 50 which is connected to the two ends of the optical fiber cores 70a and 70b among the plurality of optical fiber cores, and two branchers 80a and 80b which are provided at least at one of the optical fiber cores and branching the optical signal, one brancher 80a of the two branchers branching the optical signal from the optical signal device at one end side and the other brancher 80b branching the optical signal from the optical signal device at the other end side.

### BACKGROUND OF THE INVENTION

1. Field of the Invention

The present invention relates to an optical fiber cable network which uses a multicore optical fiber cable and a method of construction of an optical fiber cable network.

2. Description of the Related Art

In recent years, optical fiber cables have come to be utilized for distribution of broadcasts or communication in a predetermined region. Optical fiber cable networks have come to be newly constructed.

A conventional optical fiber cable network will be explained using FIG. 3. FIG. 3 is a view of the configuration which shows an example of the case of constructing an optical fiber cable network 300 by using a multicore optical fiber cable 310. The illustrated optical fiber cable network 300 is constructed so as to transmit an optical signal which is transmitted from an optical signal device 350 to eight homes in a predetermined region. The homes are set with optical receivers 390a to 390h. The optical receivers 390a to 390h are designed to be able to receive an optical signal which is transmitted from the optical signal device 350 through the optical fiber cable network 300.

The optical signal device 350 has an optical transmitter 360 which transmits an optical signal and a distributor 361 which distributes the optical signal. As illustrated, in the optical fiber cable network 300, the multicore optical fiber cable 310 is laid as an optical fiber trunk line from a closure 320 which connects with the optical transmitter 360 (below, called a “starting end closure 320”), through closures 330a to 330c (below, called “drop use closures 330a to 330c”) which are arranged on the path of the optical fiber cable 310 and from which branch optical fiber cables are dropped, and to a closure 340 which is positioned at the end of the optical fiber cable 310 (below, called “terminating end closure 340”). Further, at the drop use closures 330a to 330c or terminating end closure 340, branch optical fiber cables 372a to 372h are dropped from the optical fiber cable 310. The branch optical fiber cables 372a to 372h are connected to the optical receivers 390a to 390h at the homes.

Note that, FIG. 3 shows an optical fiber cable network 300 in the case of utilization for distributing a broadcast, but the optical fiber cable network 300 may also be used for communication of data etc. When using an optical fiber cable network for communication, the devices which are arranged at the center side become optical master devices, the terminals which are arranged at the homes become optical slave devices, and the optical master devices and optical slave devices become optical transmitters/receivers which transmit and send optical signals with each other. That is, the optical signal device 350 can not only distribute a broadcast to optical slave devices at the homes, but can also communicate with the optical slave devices. When using the optical fiber cable network 300 for communications, the optical transmitter 360 should be read as an optical transmission/reception master device, the optical receivers 390a to 390h at the homes should be read as optical transmission/reception slave devices, and the devices should be assumed to transmit and receive optical signals with each other.

The optical fiber cable 310 is a multicore optical fiber cable and for example has eight optical fiber cores 370a to 370h. The distributor 361 of the optical signal device 350 is set at the starting end closure 320. An optical signal which is transmitted from the optical transmitter 360 is distributed by the distributor 361 to the optical fiber cores 370a to 370h of the optical fiber cable 310 and transmitted by the optical fiber cores 370a to 370h.

As illustrated, the optical fiber cores 370a to 370h are dropped at the drop use closures 330a to 330c and terminating end closure 340 by splitters (sometimes called “branchers”) 380a to 380h to branch optical fiber cables 372a to 372h. The branch optical fiber cables 372a to 372h extend to the optical receivers 390a to 390h for connection. By constructing the optical fiber cable network 300 in this way, an optical signal which is transmitted from the optical transmitter 360 is transmitted to the optical receivers 390a to 390h.

In the optical fiber cable network 300, the optical fiber cable 310 is laid from the starting end closure 320 to the terminating end closure 340. Therefore, if the optical fiber cores 370a to 370h are dropped by the splitters 380a to 380b at the drop use closures 330a to 330c, the optical fiber cores which are laid from the splitters 380a to 380b to the terminating end closure 340 (parts shown by broken lines) become so-called “dark fibers” which are not used for transmission of an optical signal. The longer the distance over which the optical fiber cable 310 is laid, the more the optical fiber cores which become dark fibers increase and the more the wasted parts in construction of the optical fiber cable network.

Therefore, an optical fiber cable network which does not cause the occurrence of dark fibers has been devised. FIG. 4 is a view of the configuration which shows one example of an optical fiber cable network which was constructed for the purpose of not causing the occurrence of dark fibers.

The optical fiber cable network 400 which is shown in the figure, like the optical fiber cable network 300 of FIG. 3, is constructed so as to transmit an optical signal which is transmitted from the optical signal device 450 to the optical receivers 490a to 490h of eight homes in a predetermined region. The optical signal device 450 has an optical transmitter 460 and a distributor 461. Note that, the optical fiber cable network 400 which is shown in FIG. 4, like the optical fiber cable network 300 which is shown in FIG. 3, may be not only used for distribution of a broadcast signal, but may also be used for communication transmitting and receiving optical signals with each other. In this case, the optical transmitter 460 should be read as an optical transmission/reception master device, the optical receivers 490a to 490h at the homes should be read as optical transmission/reception slave devices, and the devices should be assumed to transmit and receive optical signals with each other.

In the optical fiber cable network 400, unlike the optical fiber cable network 300 of FIG. 3, optical fiber cables with numbers of cores equal to the numbers reduced by dropping at the drop use closures are laid between the drop use closures. Specifically, from the starting end closure 420 to the drop use closure 430a, an optical fiber cable 410 which has eight optical fiber cores 470a to 470h is laid. Further, at the drop use closure 430a, the optical fiber cores 470a and 470b are dropped to the two branch optical fiber cables 472a and 472b by the splitters 480a and 480b. From the drop use closure 430a to the drop use closure 430b, an optical fiber cable 412 which has six optical fiber cores 470c to 470h is laid. At the drop use closure 430a, the optical fiber cores 470c to 470h of the optical fiber cable 410 and the optical fiber cores 470c to 470h of the optical fiber cable 412 are connected by a connector 482. Note that, the optical fiber cores may also be connected not by connection by a connector, but by connection by melt fusion (same below).

In the drop use closure 430b, the optical fiber cores 470c and 470d are dropped to the branch optical fiber cables 472c and 472d by the splitters 480c and 480d. The drop use closure 430b and the drop use closure 430c are connected by an optical fiber cable 414 which has four optical fiber cores 470e to 470h. At the drop use closure 430b, the optical fiber cores 470e to 470h of the optical fiber cable 412 and the optical fiber cores 470e to 470h of the optical fiber cable 414 are connected by a connector 482.

In the drop use closure 430c, the optical fiber cores 470e and 470f of the optical fiber cable 414 are dropped to the branch optical fiber cables 472e and 472f by the splitters 480e and 480f.

Between the drop use closure 430c and terminating end closure 440, an optical fiber cable 416 which has two optical fiber cores 470g and 470h is laid. At the drop use closure 430c, the optical fiber cores 470g and 470h of the optical fiber cable 414 are connected with the optical fiber cores 470g and 470h of the optical fiber cable 416 by a connector 482.

At the terminating end closure 440, the optical fiber cores 470g and 470h are dropped to the branch optical fiber cables 472g and 472h by the splitters 480g and 480h.

In this way, in the optical fiber cable network 400 which is shown in FIG. 4, at the drop use closures 430a to 430c, the optical fiber cores 470a to 470f are dropped, then optical fiber cables 412 to 416 which have numbers of optical fiber cores equal to the numbers reduced by dropping are laid in the sections after the drop use closures dropped. Since optical fiber cables 412 to 416 gradually reduced in number of optical fiber cores are laid, the system becomes “telescopic” in shape. According to this system, optical fiber cables 412 to 416 which have only optical fiber cores which transmit optical signals are laid, so no dark fibers result. However, since optical fiber cables with different numbers of optical fiber cores are laid, there were the problems that design of the optical fiber cable network was difficult and, further, core management also became complicated.

Further, at the drop use closures 430a to 430c, the optical fiber cables 410 to 416 with the different numbers of cores have to be connected by connectors 482 or connected by melt fusion. The connection work at the time of laying the cables becomes complicated, so conversely the cost sometimes rose. Further, when there was a change in the number or positions of optical receivers in a region, separate optical fiber cables had to be laid and therefore handling was difficult.

Japanese Patent Publication No. 2006-20439A discloses a split type route construction method for an access type optical fiber cable and access type optical fiber system for the purpose of enabling easy core management and improving the core utilization rate.

### SUMMARY OF THE INVENTION

An optical fiber cable network using a multicore optical fiber cable where dark fibers which are not used for transmission of optical signals are reduced and where design of the optical fiber cable network or core management becomes easy has been desired.

To solve the above problems, an aspect of the invention as set forth in claim 1 provides an optical fiber cable network which is provided with an optical fiber cable which has a plurality of optical fiber cores which transmit an optical signal, an optical signal device which is connected to the two ends of at least one optical fiber core in the plurality of optical fiber cores, and two branchers which are provided at the at least one optical fiber core and which branch the optical signal, where, among the two branchers, one brancher branches the optical signal from the optical signal device at one end side while the other brancher branches the optical signal from the optical signal device at the other end side.

Further, an aspect of the invention as set forth in claim 2 provides the optical fiber cable network as set forth in claim 1 wherein the network is further provided with branch optical fiber cables which are dropped from the plurality of optical fiber cores of the optical fiber cable and a plurality of optical receivers which connect with the branch optical fiber cables and receive optical signals, each the optical signal device is provided with an optical transmitter which transmits an optical signal, a first distributor which connects the optical transmitter with one end of the optical fiber cable and distributes an optical signal which is transmitted from the optical transmitter to the plurality of optical fiber cores, and a second distributor at the other end of the optical fiber cable which is connected to the plurality of optical fiber cores so as to distribute an optical signal which is transmitted from at least one optical fiber core among the plurality of optical fiber cores to the other optical fiber cores, and each of the other optical fiber cores has the one brancher and the other brancher, and the one brancher and the other brancher are connected to the branch optical fiber cables.

Further, an aspect of the invention as set forth in claim 3 provides a method of construction of an optical fiber cable network comprising laying an optical fiber cable which has a plurality of optical fiber cores which transmit an optical signal, next, connecting, to one end of the optical fiber cable, a first distributor which distributes an optical signal to the plurality of optical fiber cores and connecting, to the other end of the optical fiber cable, a second distributor which distributes an optical signal which is transmitted from at least one optical fiber core among the plurality of optical fiber cores to other optical fiber cores, next, providing each of the other optical fiber cores with two branchers which branch optical signals, and connecting an optical transmitter which transmits an optical signal to the first distributor, among the two branchers, one brancher branching an optical signal from the first distributor and the other brancher branching an optical signal from the second distributor.

Further, an aspect of the invention as set forth in claim 4 provides the method of construction of an optical fiber cable network as set forth in claim 3, further comprising, after connecting the optical transmitter, setting an optical receiver which receives the optical signal, then laying a branch optical fiber cable which is dropped from the plurality of optical fiber cores of the optical fiber cable, then connecting the branch optical fiber cable to the optical receiver and one of the branchers which are connected to the other optical fiber cores.

Further, an aspect of the invention as set forth in claim 5 provides an optical fiber cable network group which is provided with a plurality of optical fiber cable networks as set forth in claim 1, in which optical fiber cable network group, at least one optical fiber cable network among the plurality of optical fiber cable networks provided with an optical fiber cable which transmits an optical signal to the optical signal devices of the other optical fiber cable networks.

Further, an aspect of the invention as set forth in claim 6 provides an optical fiber cable network group which is provided with a plurality of optical fiber cable networks as set forth in claim 1, the optical fiber cable network group provided with optical fiber cables which individually connect to optical signal devices of the plurality of optical fiber cable networks and which have relay use optical fiber cores which transmit optical signals.

The optical fiber cable network according to the present invention is provided with an optical signal device which is connected to the two ends of at least one optical fiber core and two branchers which are provided at that optical fiber core and which branch an optical signal. Among the two branchers, one brancher branches an optical signal from the optical signal device at one end side, while the other brancher branches an optical signal from the optical signal device at the other end side. Therefore, it is possible to for example use a single optical fiber core to transmit an optical signal to two optical receivers and possible to use an optical fiber cable which has a fewer number of cores than the past to construct an optical fiber cable network which serves a greater number of optical receivers.

Further, in a conventional optical fiber cable network, the optical fiber cores after dropping by the branchers became dark fibers which were never used for transmission of an optical signal. In the optical fiber cable network according to the present invention, it is possible to use the parts of the optical fiber cores after dropping which used to become dark fibers for transmission of an optical signal and possible to use the optical fiber cable without waste.

Further, it is possible to use optical fiber cables which have the same number of cores to construct an optical fiber cable network, so design of the optical fiber cable network becomes easier. Further, there is no need to connect optical fiber cables with different numbers of cores at the drop use closures, so the connection work at the time of laying an optical fiber cable network is lightened.

### BRIEF DESCRIPTION OF THE DRAWINGS

These objects, features, and advantages of the present invention and other objects, features, and advantages will become further clearer from the detailed description of typical embodiments of the present invention which are shown in the attached drawings, wherein

FIG. 1 is a view of the configuration which shows an example of an optical fiber cable network according to an embodiment of the present invention,

FIG. 2 is a view of the configuration which shows another example of the optical fiber cable network according to an embodiment of the present invention,

FIG. 3 is a view of the configuration which shows an example of a conventional optical fiber cable network,

FIG. 4 is a view of the configuration which shows an example of a conventional optical fiber cable network,

FIG. 5 is a view of the configuration which shows an example of an optical fiber cable network group comprising a plurality of optical fiber cable networks according to an embodiment of the present invention which are connected together,

FIG. 6 is a view of the configuration which shows another example of an optical fiber cable network group comprising a plurality of optical fiber cable networks according to an embodiment of the present invention which are connected together, and

FIG. 7 is a view of the configuration which shows another example of an optical fiber cable network group comprising a plurality of optical fiber cable networks according to an embodiment of the present invention which are connected together.

### DESCRIPTION OF EMBODIMENTS

Below, the attached figures will be referred to so as to explain the embodiments of the present invention. In the following embodiments, the same or similar members are assigned common reference signs.

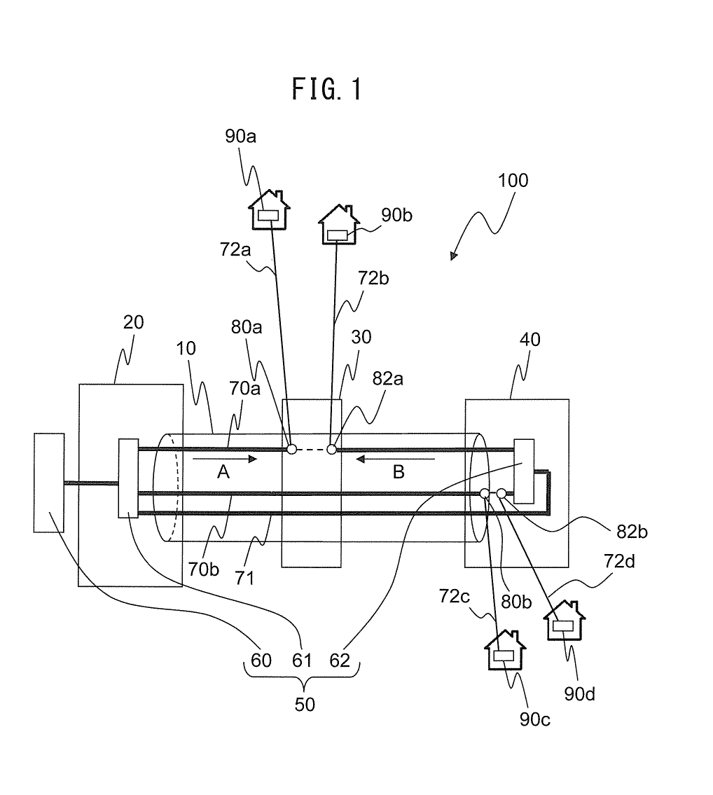

FIG. 1 is a view of the configuration which shows an example of an optical fiber cable network according to one embodiment of the present invention. The optical fiber cable network 100 of the illustrated embodiment is provided with an optical fiber cable 10 which has three optical fiber cores 70a, 70b, and 71 which transmit an optical signal, an optical signal device 50 which is connected to the two ends of the optical fiber cores 70a and 70b, and first splitters 80a and 80b (one brancher) and second splitters 82a and 82b (other branchers) which are provided at the optical fiber cores 70a and 70b and branch optical signals. The optical signal device 50 is provided with an optical transmitter 60 which transmits an optical signal, a first distributor 61 which connects the optical transmitter 60 and one end side of the optical fiber cable 10 to distribute an optical signal which is transmitted from the optical transmitter 60 to the optical fiber cores 70a, 70b, and 71, and a second distributor 62 which connects to the other end side of the optical fiber cable 10. The optical fiber cable network 100 is constructed so as to transmit an optical signal which is transmitted from the optical transmitter 60 to four homes in a predetermined region. The homes have optical receivers 90a to 90d installed in them. The optical receivers 90a to 90d are designed to be able to receive an optical signal which is transmitted from the optical transmitter 60 by the optical fiber cable network 100.

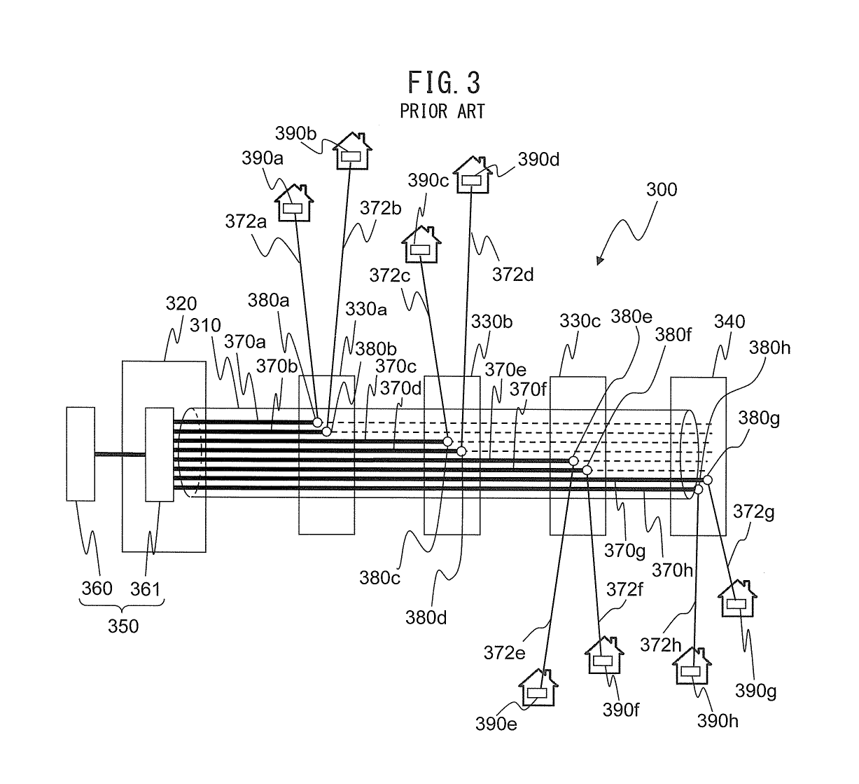

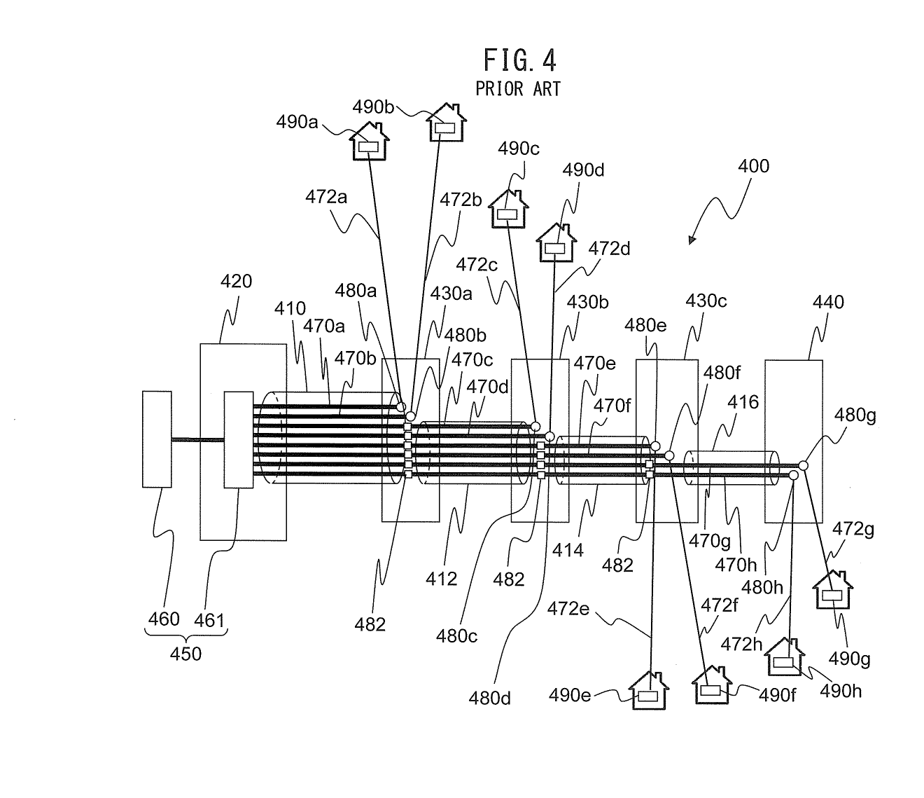

Note that, the optical fiber cable network 100 which is shown in FIG. 1, like the optical fiber cable network 300 which is shown in FIG. 3 and the optical fiber cable network 400 which is shown in FIG. 4, may not only be used to distribute a broadcast signal from the optical transmitter 60 to the optical receivers 90a to 90d, but may also be used for communication transmitting and receiving optical signals with each other. In this case, the optical transmitter 60 should be read as an optical transmission/reception master device, the optical receivers 90a to 90h at the homes should be read as optical transmission/reception slave devices, and the devices should be assumed to transmit and receive optical signals with each other.

The optical fiber cable 10 is laid from the starting end closure 20 which is positioned at one end, through the drop use closure 30, and to the terminating end closure 40 which is positioned at the other end.

The optical fiber cable 10 of the present embodiment, as explained above, has three optical fiber cores 70a, 70b, and 71. Among these, one optical fiber core 71 is used as a detour use optical fiber core which connects a first distributor 61 and a second distributor 62 without branching in the middle (below, called a “detour use optical fiber core 71”), while the other two optical fiber cores 70a and 70b are used as optical fiber cores which are dropped to the optical receivers 90a to 90d.

At the starting end closure 20, the first distributor 61 of the optical signal device 50 is provided. As illustrated, the first distributor 61 is connected with the optical transmitter 60 and one end side of the optical fiber cable 10. The first distributor 61 distributes the optical signal which is transmitted from the optical transmitter 60 to the optical fiber cores 70a and 70b and detour use optical fiber core 71 of the optical fiber cable 10. Note that, the first distributor 61 may also be configured so as to distribute the optical signal from the optical transmitter 60 by the two stages of a third distributor and a fourth distributor. It may use the third distributor to distribute the optical signal which is transmitted from the optical transmitter 60 to the detour use optical fiber core 71 and the fourth distributor and further to use the fourth distributor to distribute the optical signal to the optical fiber cores 70a and 70b.

The terminating end closure 40 is provided with the second distributor 62. The second distributor 62 is connected so as to distribute an optical signal which is transmitted from the first distributor 61 by the detour use optical fiber core 71 to another two optical fiber cores 70a and 70b of the optical fiber cable 10. For this reason, the optical fiber cores 70a and 70b are designed to be able to transmit an optical signal which is transmitted from the first distributor 61 in the arrow A direction of the figure and an optical signal which is transmitted by the detour use optical fiber core 71, distributed by the second distributor 62, and transmitted in the arrow B direction of the figure.

At the drop use closure 30, the pair of homes near the drop use closure 30 among the four homes which are serviced by the optical fiber cable network 100, that is, the pair of optical receivers 90a, 90b, are selected, and branch optical fiber cables 72a and 72b are extended from the drop use closure 30 for connection to the optical receivers 90a and 90b.

The optical fiber core 70a is dropped at the drop use closure 30 by the first splitter 80a (one brancher) to the branch optical fiber cable 72a. The branch optical fiber cable 72a is extended to the optical receiver 90a for connection. By the optical transmitter 60 and the optical receiver 90a being connected in this way, an optical signal from the first distributor 61 of the optical signal device 50 which is connected with one end side of the optical fiber cable 10 is branched. That is, the optical signal which is transmitted from the optical transmitter 60 is distributed by the first distributor 61 to the optical fiber core 70a, then is transmitted by the optical fiber core 70a, is branched by the first splitter 80a to the branch optical fiber cable 72a, and is transmitted to the optical receiver 90a. Note that, due to the first splitter 80a, the optical signal from the first distributor 61 is branched so as to be transmitted to the branch optical fiber cable 72a. The optical signal from the first distributor 61 is prevented from being transmitted to the optical fiber core 70a after branching.

The optical fiber core 70a is provided with a second splitter 82a (other brancher) at the drop use closure 30 between the first splitter 80a and the second distributor 62. The second splitter 82a branches the optical signal from the second distributor 62 of the optical signal device 50 which is connected to the other end side of the optical fiber cable 10, that is, the optical signal which is transmitted in the arrow B direction of the figure, to the branch optical fiber cable 72b. The branch optical fiber cable 72b extends to the optical receiver 90b and is connected with the optical receiver 90b. The optical receiver 90b can receive the optical signal from the second distributor 62. That is, the optical signal which is transmitted from the optical transmitter 60 is distributed by the first distributor 61 to the detour use optical fiber core 71, is transmitted by the detour use optical fiber core 71 to the second distributor 62 of the terminating end closure 40, further is distributed by the second distributor 62 to the optical fiber core 70a, then is transmitted by the optical fiber core 70a to the arrow B direction of the figure, and is split by the second splitter 82a to the branch optical fiber cable 72b and transmitted to the optical receiver 90b. Note that, the second splitter 82a is used to split the optical signal from the second distributor 62 to transmit it to the branch optical fiber cable 72b. The optical signal from the second distributor 62 is prevented from being transmitted to the optical fiber core 70a after branching.

Note that, in the illustrated embodiment, single branch optical fiber cables 72a and 72b are dropped from the first splitter 80a and the second splitter 82a, but the numbers of dropped branch optical fiber cables are not limited to single ones. Several branch optical fiber cables may also be dropped from the first splitter 80a and second splitter 82a. That is, the optical fiber cable network may also be constructed so that optical signals are transmitted to several optical receivers by the pluralities of branch optical fiber cables which are dropped from the first splitter 80a and the second splitter 82a.

The transmission distance of an optical signal from the first distributor 61 to the optical receiver 90b passes through the second distributor 62 of the terminating end closure 40, so becomes longer than the transmission distance from the first distributor 61 to the optical receiver 90a. Usually, when using a metal cable to transmit a signal, the amount of attenuation per unit length becomes large and distance can easily have an effect, so the transmission distance is preferably shortened. For this reason, the practice had never been to connect from the first distributor 61 through the second distributor 62 to the optical receiver 90b. In the present embodiment, an optical fiber cable is used to transmit an optical signal. An optical fiber has a smaller amount of attenuation per unit length compared with a metal cable, so is less affected by the transmission path becoming longer. For this reason, the optical fiber cable network 100 according to the present embodiment can transmit a signal with little attenuation of the signal and at a sufficiently practical intensity (level) to the optical receivers of the homes even if the transmission distance becomes longer by going through the second distributor 62.

At the terminating end closure 40, the pair of homes near the terminating end closure 40 among the four homes which are serviced by the optical fiber cable network 100, that is, the pair of optical receivers 90c and 90d, are selected, and branch optical fiber cables 72c and 72d are extended from the terminating end closure 40 for connection.

The optical fiber core 70b is dropped at the terminating end closure 40 by the first splitter 80b (one brancher) to the branch optical fiber cable 72c. Further, the branch optical fiber cable 72c is extended to the optical receiver 90c for connection. By the optical transmitter 60 and the optical receiver 90c being connected in this way, an optical signal which is transmitted from the optical transmitter 60 is distributed by the first distributor 61 to the optical fiber core 70b, then is transmitted by the optical fiber core 70b, is branched by the first splitter 80b to the branch optical fiber cable 72c, and is transmitted to the optical receiver 90c.

Further, the optical fiber core 70b is dropped to the branch optical fiber cable 72d by a second splitter 82b (other brancher) which is provided at the terminating end closure 40 between the first splitter 80b and the second distributor 62. The branch optical fiber cable 72d extends from the second splitter 82b to the optical receiver 90d and is connected with the optical receiver 90d. By connecting the optical transmitter 60 and the optical receiver 90d in this way, the optical signal which is transmitted from the optical transmitter 60 is distributed by the first distributor 61 to the detour use optical fiber core 71, is transmitted by the detour use optical fiber core 71 to the second distributor 62, is distributed by the second distributor 62 to the optical fiber core 70b, then is branched by the second splitter 82b to the branch optical fiber cable 72d and is transmitted to the optical receiver 90d.

A method of construction of an optical fiber cable network 100 of the present embodiment will be explained. First, an optical fiber cable 10 which has a plurality of optical fiber cores 70a, 70b, and 71 which transmit optical signals is laid. Next, the first distributor 61 of the optical signal device 50 is connected to the starting end of the optical fiber cores 70a, 70b, and 71 of the optical fiber cable 10, while the second distributor 62 of the optical signal device 50 is connected to the terminating end. Next, first splitters 80a and 80b and second splitters 82a and 82b are provided at the optical fiber cores 70a and 70b. Next, the optical transmitter 60 of the optical signal device 50 is connected to the input end of the first distributor 61. Due to this, the optical signal of the optical transmitter 60 flows to the first splitters 80a and 80b and the second splitters 82a and 82b. Next, optical receivers 90a to 90d are installed as required at the homes requesting connection, branch optical fiber cables 72a to 72d are laid as required, and the cables are connected with the optical receivers 90a to 90d as required. Next, the other ends of the branch optical fiber cables 72a to 72d are connected to the first splitters 80a and 80b and the second splitters 82a and 82b as required.

If using the conventional system which is shown in FIG. 3 to lay an optical fiber cable network, the optical fiber core 70a after splitting at the first splitter 80a becomes a dark fiber which is never used. In the present embodiment, by connecting the second distributor 62 of the optical signal device 50 to the other end of the optical fiber cable 10, an optical signal from the optical signal device 50 (second distributor 62) is transmitted to the optical fiber core of the part forming the dark fiber and is branched by the second splitter 82a at the optical receiver 90b. For this reason, it is possible to effectively utilize the optical fiber core 70a which was laid to the terminating end closure 40.

Further, when constructing an optical fiber cable network which transmits an optical signal to four splitters by the conventional system which is shown in FIG. 3, it is necessary to use an optical fiber cable which has at least four optical fiber cores. At the optical fiber cable network 100 of the present embodiment which is shown in FIG. 1, it is possible to use an optical fiber cable 10 which has three optical fiber cores 70a, 70b, and 71 to transmit an optical signal through four splitters (first splitters 80a, 80b and second splitters 82a, 82b) to four optical receivers 90a to 90d. That is, by providing the first distributor 61 and second distributor 62 at the two ends of the optical fiber cable 10, it is possible to use an optical fiber cable which has the number of optical fiber cores which is found by equation 1 so as to construct an optical fiber cable network:

N=M/2+S (1)

where, N is the number of optical fiber cores of the optical fiber cable, M is the number of splitters, and S is the number of detour use optical fiber core. It is possible to use an optical fiber cable 10 which has a number of optical fiber cores smaller than the number of optical fiber cores of a conventional optical fiber cable network, so it is possible to reduce the cost of laying an optical fiber cable network.

Further, in the optical fiber cable network 100 of the present embodiment which is shown in FIG. 1, optical fiber cables 10 of the same number of cores are laid from the starting end closure 20 to the terminating end closure 40. It is not necessary to prepare optical fiber cables of different numbers of cores for the individual sections between closures, so design of the optical fiber cable network and core management are easy. Further, unlike the optical fiber cable network 400 which is laid in a telescopic shape which is shown in FIG. 4, it is not necessary to connect optical fiber cables with different numbers of cores at the drop use closures, so it is possible to lighten the connection work when constructing an optical fiber cable network.

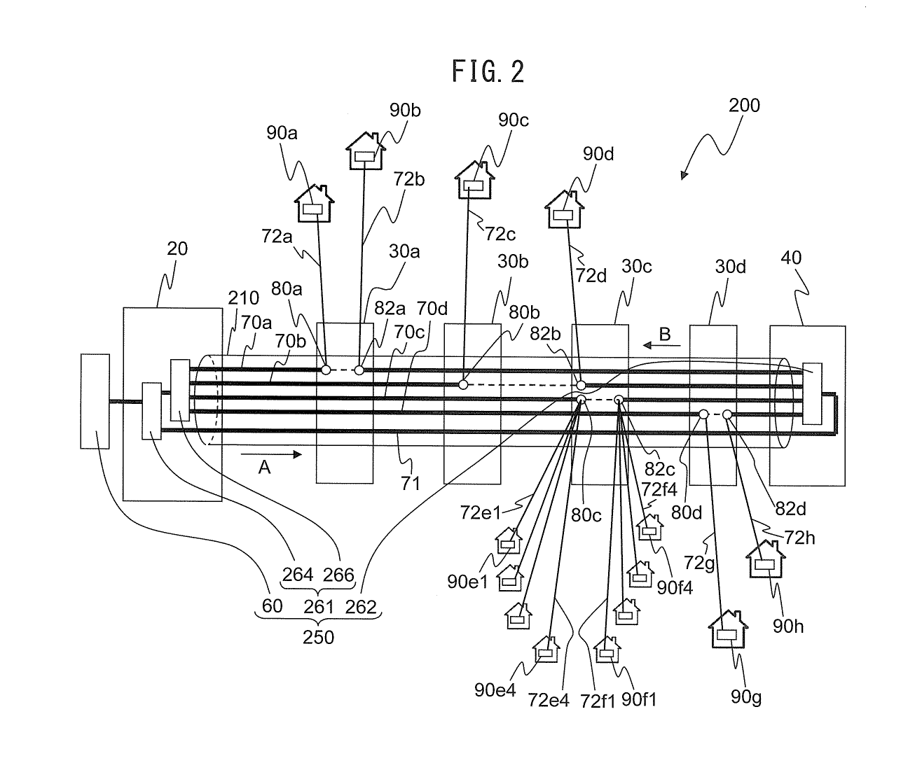

FIG. 2 is a view of the configuration which shows another example of an optical fiber cable network according to an embodiment of the present invention. The optical fiber cable network 200 of the illustrated embodiment is constructed using a multicore optical fiber cable 210 so as to transmit an optical signal which is transmitted from an optical signal device 250 to a plurality of homes in a predetermined region. The optical fiber cable network 200 of the illustrated embodiment is provided with an optical fiber cable 210 which has a plurality of optical fiber cores 70a to 70d and 71 which transmit optical signals, an optical signal device 250 (including a later explained optical transmitter 60, first distributor 261, and second distributor 262) which is connected to the two ends of the optical fiber cores 70a to 70d, and first splitters 80a to 80d (one brancher) and second splitters 82a to 82d (other branchers) which are provided at the optical fiber cores 70a to 70d and split the optical signals.

The optical signal device 250 is provided with an optical transmitter 60 which transmits an optical signal, a first distributor 261 which connects the optical transmitter 60 and one end side of the optical fiber cable 210 and distributes the optical signal which is transmitted from the optical transmitter 60 to the optical fiber cores 70a to 70d and 71, and a second distributor 262 which connects to the other end side of the optical fiber cable 210.

At the homes, optical receivers 90a to 90d, 90e1 to 90e4, 90f1 to 90f4, 90g, and 90h (below, sometimes together indicated as the “optical receivers 90”) are installed. The optical receivers 90 are designed to be able to receive the optical signal which is transmitted from the optical transmitter 60 by the optical fiber cable network 200.

Note that, the optical fiber cable network 200 which is shown in FIG. 2, like the optical fiber cable networks which are shown in FIG. 1, FIG. 3, and FIG. 4, may be not only used for distribution of a broadcast signal from an optical transmitter 60 to the optical receivers 90, but may also be used for communication transmitting and receiving an optical signal. In this case, the optical transmitter 60 should be read as an optical transmission/reception master device, the optical receivers 90 at the homes should be read an optical transmission/reception slave devices, and these should be assumed to transmit and receive optical signals with each other.

The optical fiber cable 210 of the illustrated embodiment, as explained above, has five optical fiber cores. Among these, one optical fiber core 71 is used as a detour use optical fiber core 71 which connects the first distributor 261 and second distributor 262 without being dropped midway, while the other four optical fiber cores 70a to 70d are used as optical fiber cores which are dropped to the optical receivers 90.

The optical fiber cable 210 is laid from the starting end closure 20 through the drop use closures 30a to 30d at the four locations to the terminating end closure 40.

At the starting end closure 20, a first distributor 261 is provided. The first distributor 261 connects an optical transmitter 60 which transmits an optical signal and one end of the optical fiber cable 210. The first distributor 61 which is shown in FIG. 1 used a single distributor to distribute optical signals, but the first distributor 261 which is shown in FIG. 2 is comprised of two distributors (third distributor 264 and fourth distributor 266). The optical signal which is transmitted from the optical transmitter 60 is distributed by the third distributor 264 to the fourth distributor 266 and the detour use optical fiber core 71 of the optical fiber cable 210. Further, the optical signal which is distributed by the third distributor 264 to the fourth distributor 266 is distributed by the fourth distributor 266 to still another four optical fiber cores 70a to 70d. By configuration in this way, the optical signals which are distributed by the second distributor 262 and the fourth distributor 266 to the optical fiber cores 70a to 70d can be made the same level.

The detour use optical fiber core 71 which is connected to the third distributor 264 is laid to the terminating end closure 40 without being dropped at the drop use closures 30a to 30d. At the terminating end closure 40, the second distributor 262 is provided. The second distributor 262 is connected to an end of the optical fiber cable 210 so as to distribute an optical signal which is transmitted by the detour use optical fiber core 71 to another four optical fiber cores 70a to 70d of the optical fiber cable 210.

For this reason, the optical fiber cores 70a to 70d can transmit the optical signal which is transmitted from the fourth distributor 266 of the first distributor 261 in the arrow A direction of the figure and the optical signal which is transmitted from the second distributor 262 in the arrow B direction of the figure.

At the drop use closure 30a, two homes near the drop use closure 30a among the plurality of homes which are serviced by the optical fiber cable network 200, that is, two optical receivers 90a and 90b, are selected, and branch optical fiber cables 72a and 72b are extended from the drop use closure 30a for connection.

The optical fiber core 70a of FIG. 2 is dropped at the drop use closure 30a by the first splitter 80a to a branch optical fiber cable 72a. Due to this, an optical signal which is transmitted from the fourth distributor 266 by the optical fiber core 70a is transmitted to the branch optical fiber cable 72a, so the optical receiver 90a can receive the optical signal.

Further, the optical fiber core 70a is dropped at the drop use closure 30a by the second splitter 82a which is provided between the first splitter 80a and the second distributor 262 to the branch optical fiber cable 72b. The branch optical fiber cable 72b is extended to the optical receiver 90b for connection. Due to this, the optical signal which is transmitted from the optical transmitter 60 is distributed through the third distributor 264 and the detour use optical fiber core 71 by the second distributor 262 to the optical fiber core 70a, is transmitted by the optical fiber core 70a in the arrow B direction, is branched by the second splitter 82a to the branch optical fiber cable 72b, and is transmitted to the optical receiver 90b.

At the drop use closure 30b, the optical receiver 90c of a single home near the drop use closure 30b in a plurality of homes which are serviced by the optical fiber cable network 200 is selected, and the branch optical fiber cable 72c is extended from the drop use closure 30b for connection. Further, at the drop use closure 30c, the optical receivers 90d, 90e1 to 90e4, and 90f1 to 90f4 of nine homes near the drop use closure 30c in the homes which the optical fiber cable network 200 services are selected, and the branch optical fiber cables 72d, 72e1 to 72e4, 72f1 to 72f4 extend from the drop use closure 30c and are connected to the optical receivers 90d, 90e1 to 90e4, and 90f1 to 90f4.

The optical fiber core 70b is split at the drop use closure 30b by the first splitter 80b to a branch optical fiber cable 72c. The optical signal which is transmitted from the fourth distributor 266 by the optical fiber core 70b is branched to the branch optical fiber cable 72c and transmitted to the optical receiver 90c.

Further, the optical fiber core 70b is dropped at the drop use closure 30c by the second splitter 82b to the branch optical fiber cable 72d, then the branch optical fiber cable 72d is extended to the optical receiver 90d for connection. By connection in this way, the optical signal which is transmitted from the second distributor 262 can be transmitted to the optical receiver 90d.

In this way, the second splitter 82b need not be provided at the same drop use closure as the first splitter 80b. That is, so long as between the first splitter 80b and the second distributor 262, as illustrated, the second splitter 82b may also be provided at the drop use closure 30c. Further, the second splitter 82b may also be provided at the terminating end closure 40. The optical fibers between the first splitter 80b and the second splitter 82b (shown by the broken lines) are not used for transmission of an optical signal, but enable any changes in the positions or numbers of optical receivers which are connected to the drop use closures to be handled without newly laying optical fiber cables.

The optical fiber core 70c, compared with the optical fiber core 70a, differs in that the first splitter 80c is used to drop it to four branch optical fiber cables 72e1 to 72e4 and connect to the optical receivers 90e1 to 90e4 of four homes and that the second splitter 82c is used to drop it to four branch optical fiber cables 72f1 to 72f4 and connect to the optical receivers 90f1 to 90f4 of four homes. In this way, it is possible to use the first splitter 80c and the second splitter 82c to drop to a plurality of branch optical fiber cables and connect to a plurality of optical receivers. Note that, when using the splitters to drop to a plurality of branch optical fiber cables, it is preferable to make the numbers of cables which are dropped by the splitters the same so as to make the levels of the optical signals which are transmitted to the optical receivers the same.

The optical fiber core 70d, compared with the optical fiber core 70a, differs in that the positions of providing the first splitter 80d and second splitter 82d are the drop use closure 30d. The rest of the configuration is similar to the optical fiber core 70a, so a detailed description will be omitted.

In the conventional system, an optical fiber core after dropping by the splitter became a dark fiber which is not used for transmission of an optical signal, so in the optical fiber cable network 200 of the present embodiment, it is possible to transmit an optical signal from the terminating end closure 40, that is, the terminating end side of the optical fiber cable 210, to the optical fiber core so as to branch and transmit an optical signal to two optical receivers and possible to effectively use a part which used to become a dark fiber.

Further, in a conventional optical fiber cable network, as shown in FIG. 3, to provide eight splitters so as to lay optical fibers to eight optical receivers, an optical fiber cable which has eight optical fiber cores was used. In the case of the optical fiber cable network 200 of the present embodiment, it is possible to use an optical fiber cable 210 which has five optical fiber cores, smaller than the number of optical fiber cores of a conventional optical fiber cable network, to set eight splitters (first splitters 80a to 80d and second splitters 82a to 82d) and construct an optical fiber cable network 200 for a plurality of optical receivers 90. It is possible to use an optical fiber cable with a smaller number of cores than the number of optical fiber cores of a conventional optical fiber cable network so as to construct an optical fiber cable network and in turn is possible to reduce the installation cost. Note that, in the embodiments which are shown in FIGS. 1 and 2, the explanation was given of the case of laying an optical fiber cable network which uses an optical fiber cable which has three or five optical fiber cores, but the number of cores of the optical fiber cable is not limited. To transmit optical signals to more optical receivers, it is also possible to use an optical fiber cable which has five or more optical fiber cores. Further, it is also possible to lay a plurality of optical fiber cables which have pluralities of optical fiber cores bundled together.

Further, since an optical fiber cable 210 which has the same number of optical fiber cores is laid from the starting end closure 20 to the terminating end closure 40, there is no need to prepare optical fiber cables with different numbers of cores for individual closure sections such as in the optical fiber cable network 400 according to the telescopic system which is shown in FIG. 4, so design of the optical fiber cable network and core management are easy. Further, there is no need to connect optical fiber cables with different numbers of cores at the drop use closures and it is possible to lighten the connection work at the time of laying cables.

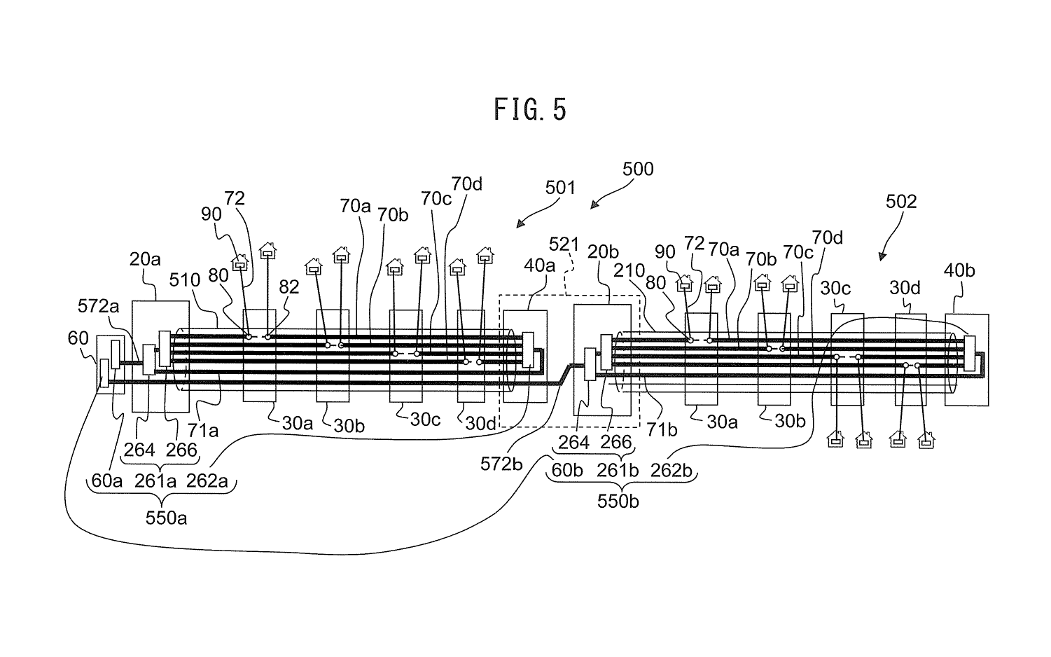

Next, using FIG. 5, an optical fiber network comprised of a plurality of optical fiber cable networks connected together according to present embodiment (below, referred to as an “optical fiber cable network group”) will be explained. The optical fiber cable network group 500 of the illustrated embodiment is an optical fiber cable network group which is comprised of a plurality of the optical fiber cable networks which are shown in FIG. 2 connected together and specifically is comprised of the first optical fiber cable network 501 and the second optical fiber cable network 502. The optical fiber cable network group 500 is provided with a first optical fiber cable network 501 and an optical transmitter 60 which transmits an optical signal to a second optical fiber cable network 502. The optical transmitter 60 is comprised of the two first optical transmitter 60a and second optical transmitter 60b. The first optical fiber cable network 501 is provided with an optical fiber cable 510 which transmits an optical signal to an optical signal device 550b of the second optical fiber cable network 502. The optical fiber cable 510 is provided with a relay use optical fiber core 572b which connects the second optical transmitter 60b of the optical transmitter 60 and a first distributor 261b which connects the optical transmitter 60b and the second optical fiber cable network 502.

The optical signal device 550a of the first optical fiber cable network 501 is comprised of a first optical transmitter 60a which transmits an optical signal to the first optical fiber cable network 501 and a first distributor 261a and a second distributor 262a which distribute an optical signal which is transmitted from the first optical transmitter 60a to the two ends of the optical fiber cores 70a to 70d of the first optical fiber cable network 501. The first optical transmitter 60a and the first distributor 261a are connected by a relay use optical fiber core 572a. The first distributor 261a and the second distributor 262a are connected by a detour use optical fiber core 71a. Further, the first distributor 261a is provided with a third distributor 264 and a fourth distributor 266. Further, the first distributor 261a is installed at the starting end closure 20a, while the second distributor 262a is installed at the terminating end closure 40a.

The first optical fiber cable network 501 is configured substantially the same as the optical fiber cable network 200 which is shown in FIG. 2, but if comparing the optical fiber cable network 200 and the first optical fiber cable network 501, the first optical fiber cable network 501 differs in that it is provided with a relay use optical fiber core 572b which extends from the second optical transmitter 60b and transmits the optical signal to the second optical fiber cable network 502. The relay use optical fiber core 572b of the illustrated embodiment utilizes a single optical fiber core among the plurality of optical fiber cores of the optical fiber cable 510. The rest of the functions of the components of the first optical fiber cable network 501 and the method of transmitting an optical signal to the optical receivers 80 of the homes are similar to the optical fiber cable network 200 of FIG. 2, so detailed explanations will be omitted. Note that, the number of drops from the first splitter 80 and second splitter 82 may be any number in the same way as the optical fiber cable network 200 of FIG. 2. Two or more optical receivers 90 may be dropped to.

The optical signal device 550b of the second optical fiber cable network 502 is provided with a first distributor 261b and a second distributor 262b which distribute an optical signal which is transmitted from the second optical transmitter 60b to the two ends of the optical fiber cores 70a to 70d of the optical fiber cable 210. Further, the first distributor 261b is installed in the starting end closure 20b, while the second distributor 262b is installed in the terminating end closure 40b.

The second optical fiber cable network 502 is configured substantially the same as the optical fiber cable network 200 which is shown in FIG. 2, but the second optical fiber cable network 502 differs in that the second optical transmitter 60b and the first distributor 261b are connected through the relay use optical fiber core 572b of the first optical fiber cable network 501. The rest of the functions of the components of the second optical fiber cable network 502 and the method of transmitting an optical signal to the optical receivers 90 of the homes are similar to the optical fiber cable network 200 of FIG. 2, so detailed explanations will be omitted.

In the optical fiber cable network 200 which is shown in FIG. 2, the first splitters 80a to 80d (below, sometimes referred to together as the “first splitters 80”) and the second splitters 82a to 82d (below, sometimes referred to together as the “second splitters 82”) are provided. Four drop use closures 30a to 30d (below, sometimes referred to together as the “drop use closures 30”) which drop the branch optical fiber cables 72a to 72h (below, sometimes referred to together as the “branch optical fiber cables 72”) are provided. Sometimes, with the configuration of the optical fiber cable network 200 as is, the optical fiber cable 210 is extended, the number of drop use closures is further increased, and the cores of the optical fiber cable are increased. That is, when extending the optical fiber cable 210 and setting drop use closures 30 at a total of eight locations, a single detour use optical fiber cable 71 and eight optical fiber cores 70 may be used to construct an optical fiber cable network 200.

On the other hand, as shown in the embodiment which is shown in FIG. 5, if constructing the second optical fiber cable network 502 and using a relay use optical fiber core 572b which passes through the first optical fiber cable network 501 to connect the optical transmitter 60 and the first distributor 261b of the second optical fiber cable network 502, since the distance up to the optical transmitter 60 and the second optical fiber cable network 502 is connected by the single relay use optical fiber core 572b, even without increasing the cores of the optical fiber cable, it is possible to increase the second optical fiber cable network 502 and possible to construct an optical fiber cable network group which has drop use closures 30 at a total of eight locations. That is, by providing a plurality of unused cores in advance, it becomes possible to construct an optical fiber cable network group over a broader range even without increasing the cores of the optical fiber cable. In the optical fiber cable network group 500 according to the embodiment which is shown in FIG. 5, it is possible to connect a plurality of optical fiber cable networks which, while the first distributor 261b and the second distributor 262b are added, have fewer numbers of cores and have the same specifications so as to construct an optical fiber cable network group, so it is possible to facilitate the design of the optical fiber cable network. Further, it is possible to connect a greater number of optical fiber cable networks of the same specifications so as to enable the optical fiber cable network to fall in unit price and the cost of constructing the optical fiber cable network group as a whole to be reduced.

Note that, in the optical fiber cable network group 500 which is shown in FIG. 5, the terminating end closure 40a of the optical fiber cable network 501 and the starting end closure 20b of the optical fiber cable network 502 function independently, but it is also possible to set the same closures surrounded by broken lines (relay use closure 521) so as to jointly use the terminating end closure 40a and starting end closure 20b. Further, the optical fiber cable network group 500 which is shown in FIG. 5 is configured by two optical fiber cable networks (first optical fiber cable network 501 and second optical fiber cable network 502), but the optical fiber cable network group 500 may also be configured from three or more optical fiber cable networks. When adding a third optical fiber cable network (not shown), the third optical fiber cable network may be set so as to extend from the terminating end closure 40a of the first optical fiber cable network 501 in a separate direction from the second optical fiber cable network 502. Further, the third optical fiber cable network may be set so as to further extend from the terminating end closure 40b of the second optical fiber cable network 502. In this case, the optical transmitter 60 and the first distributor of the third optical fiber cable network are connected by a relay use optical fiber core, separate from the relay use optical fiber core 572b, which passes through the first optical fiber cable network 501 and the optical fiber cable 210 of the second optical fiber cable network 502. An optical fiber cable which has a plurality of relay use optical fiber cores which include a relay use optical fiber core 572b may be set, separate from the optical fiber cables 510 and 210, along the optical fiber cables 510 and 210 and connect the optical transmitter 60 and second optical fiber cable network 502 and third optical fiber cable network.

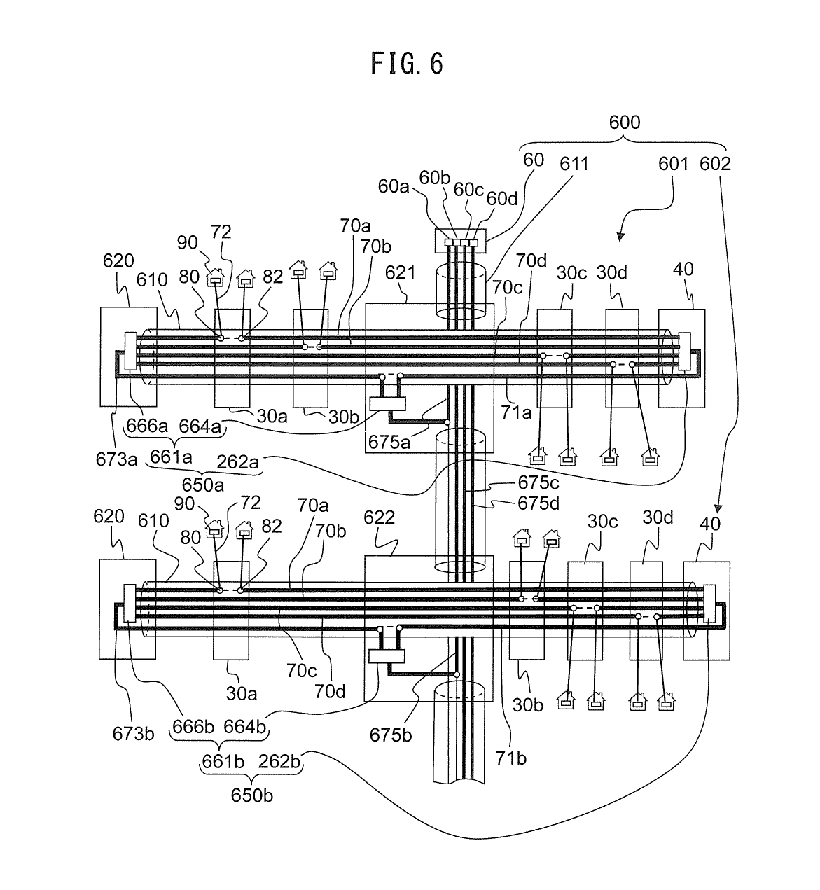

Next, using FIG. 6, another example of an optical fiber cable network group comprised of a plurality of optical fiber cable networks of the embodiment which is shown in FIG. 2 connected together will be explained.

FIG. 6 is a view of the configuration which shows the configuration of the optical fiber cable network group 600. The optical fiber cable network group 600 is provided with a first optical fiber cable network 601, a second optical fiber cable network 602, a relay use optical fiber cable 611, and an optical transmitter 60 which transmits an optical signal to the relay use optical fiber cable 611. The relay use optical fiber cable 611 has relay use optical fiber cores 675a to 675d which individually connect to and transmit optical signals over the optical signal device 650a of the first optical fiber cable network 601 and the optical signal device 650b of the second optical fiber cable network 602. The optical transmitter 60 is comprised of a first optical transmitter 60a, second optical transmitter 60b, third optical transmitter 60c, and fourth optical transmitter 60d which transmit optical signals to the relay use optical fiber cores 675a to 675d.

The optical signal device 650a of the first optical fiber cable network 601 is provided with a first distributor 661a and second distributor 262a which distribute an optical signal which is transmitted from the first optical transmitter 60a to the two ends of the optical fiber cores 70a to 70d of the first optical fiber cable network 601. The first distributor 661a has a third distributor 664a and a fourth distributor 666a. The third distributor 664a connects with the relay use optical fiber core 675a and distributes an optical signal which is transmitted from the first optical transmitter 60a to the second distributor 262a and the fourth distributor 666a. The third distributor 664a and the second distributor 262a are connected by the detour use optical fiber core 71a, while the third distributor 664a and the fourth distributor 666a are connected by the detour use optical fiber core 673a.

The optical signal device 650b of the second optical fiber cable network 602 is provided with a first distributor 661b and a second distributor 262b which distribute an optical signal which is transmitted from the second optical transmitter 60b to the two ends of the optical fiber cores 70a to 70d of the second optical fiber cable network 602. The first distributor 661b has a third distributor 664b and a fourth distributor 666b. The third distributor 664b connects with the relay use optical fiber core 675b and distributes the optical signal which is transmitted from the second optical transmitter 60b to the second distributor 262b and the fourth distributor 666b. The third distributor 664b and the second distributor 262b are connected by the detour use optical fiber core 71b, while the third distributor 664b and the fourth distributor 666b are connected by the detour use optical fiber core 673b.

If compared with the optical fiber cable network group 500 which is shown in FIG. 5, the optical fiber cable network group 600 differs in that, for connection of the optical transmitter 60 and the plurality of optical fiber cable networks, a relay use optical fiber cable 611 which has relay use optical fiber cores 675a to 675d is used.

The relay use optical fiber cable 611 of the illustrated embodiment is comprised of four relay use optical fiber cores 675a to 675d bundled together. The starting end side ends of the four optical fiber cores are connected to the first optical transmitter 60a to fourth optical transmitter 60d of the optical transmitter 60. Further, the relay use optical fiber cable 611 intersects the first optical fiber cable network 601 at the relay use closure 621. The relay use optical fiber core 675a of the relay use optical fiber cable 611 is dropped and connected to the third distributor 664a of the first optical fiber cable network 601. Further, the relay use optical fiber cable 611 intersects the second optical fiber cable network 602 at the relay use closure 622. Further, the relay use optical fiber core 675b of the relay use optical fiber cable 611 is dropped and connected to the third distributor 664b of the second optical fiber cable network 602.

The optical fiber cable network group 600 may further be provided with two optical fiber cable networks (not shown). The relay use optical fiber cores 675c and 675d of the relay use optical fiber cable 611 may be dropped and connected to the added optical fiber cable network. The relay use optical fiber cable 611 is provided with the same number of optical fiber cores as the number of optical fiber cable networks which are connected.

The first optical fiber cable network 601 has substantially the same configuration as the optical fiber cable network 200 which is shown in FIG. 2, but if comparing the optical fiber cable network 200 and the first optical fiber cable network 601, this differs in that in the first optical fiber cable network 601, the third distributor 644a which forms part of the first distributor 661 is set in the relay use closure 621 which is arranged between the drop use closure 30b and the drop use closure 30c and where the first optical fiber cable network 601 and the relay use optical fiber cable 611 intersect and in that the detour use optical fiber core 673a of the optical fiber cable 610 connects the third distributor 664a and the fourth distributor 666a of the starting end closure 620. Further, as explained above, the relay use optical fiber core 675a of the relay use optical fiber cable 611 connects the third distributor 664a and the first optical transmitter 60a of the optical transmitter 60. Other than the location of installation of the third distributor 664a and the connection of the third distributor 664a and fourth distributor 666a, the configuration is the same as the optical fiber cable network 200 which is shown in FIG. 2, so a detailed explanation will be omitted.

The second optical fiber cable network 602 as well has substantially the same configuration as the optical fiber cable network 200 which is shown in FIG. 2, but if comparing the optical fiber cable network 200 and the second optical fiber cable network 602, this differs in that in the second optical fiber cable network 602, the third distributor 644b which forms part of the first distributor 661b is set in the relay use closure 622 which is arranged between the drop use closure 30a and the drop use closure 30b and where the second optical fiber cable network 602 and the relay use optical fiber cable 611 intersect and in that the detour use optical fiber core 673b of the optical fiber cable 610 connects the third distributor 664b and the fourth distributor 666b of the starting end closure 620. Further, as explained above, the relay use optical fiber core 675b of the relay use optical fiber cable 611 connects the third distributor 664b and the optical transmitter 60. Other than the location of installation of the third distributor 664b and the connection of the third distributor 664b and fourth distributor 666b, the configuration is the same as the optical fiber cable network 300 which is shown in FIG. 2, so a detailed explanation will be omitted.

The points where the relay use optical fiber cable 611 and the optical fiber cable network intersect (relay use closures 621 and 622) may be made any locations. In the embodiment which is shown in FIG. 6, in the case of the first optical fiber cable network 601, the relay use closure 621 is set between the drop use closures 30b and 30c and, in the case of the second optical fiber cable network 602, the relay use closure 622 is set between the drop use closures 30a and 30b, but the relay use closure may be set between the drop use closures 30c and 30d or may be set between the starting end closure 620 and the drop use closure 30a. Further, the relay use closure may double as a starting end closure 620, drop use closure 30, or terminating end closure 40.

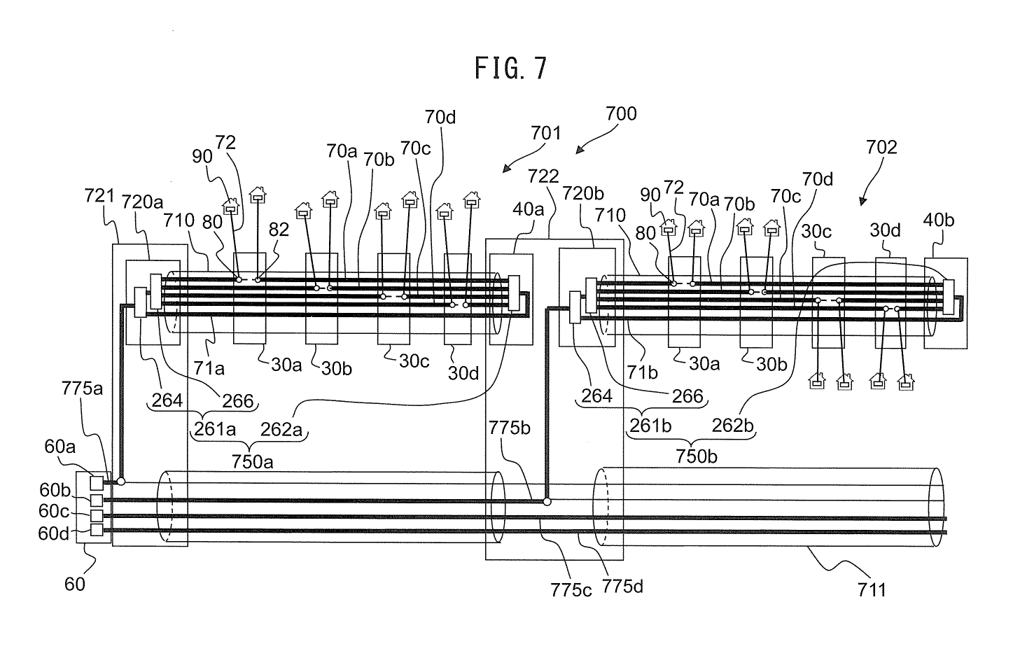

The optical fiber cable network group 700 which is shown in FIG. 7 is a modification of the optical fiber cable network group 600 which is shown in FIG. 6. The optical fiber cable network group 700 is provided with a first optical fiber cable network 701, second optical fiber cable network 702, relay use optical fiber cable 711, and optical transmitter 60 which transmits an optical signal to the relay use optical fiber cable. The relay use optical fiber cable 711 has relay use optical fiber cores 775a to 775d which individually connect to the optical signal device 750a of the first optical fiber cable network 701 or the optical signal device 750b of the second optical fiber cable network 702 and transmit the optical signal. The optical transmitter 60 is comprised of a first optical transmitter 60a, second optical transmitter 60b, third optical transmitter 60c, and fourth optical transmitter 60d which transmit optical signals to the relay use optical fiber cores 775a to 775d.

In the optical fiber cable network group 700 which is shown in FIG. 7, the relay use optical fiber cable 711 is laid in parallel with the optical fiber cable 710 of the first optical fiber cable network 701 and the optical fiber cable 710 of the second optical fiber cable network 702. Therefore, in the optical fiber cable network group 600 which is shown in FIG. 6, the relay use closure 621 is provided separate from the starting end closure 620, but in the optical fiber cable network group 700, as shown in the figure, the relay use closure 721 at which the optical fiber core 775a is dropped can double as the starting end closure 720a of the first optical fiber cable network 701. Further, the relay use closure 722 at which the optical fiber core 775b is dropped can double as the terminating end closure 40a of the first optical fiber cable network 701 and the starting end closure 720b of the second optical fiber cable network 702 together. The first optical fiber cable network 701 and the second optical fiber cable network 702 are configured substantially the same as the optical fiber cable network 200 which is shown in FIG. 2, so a detailed explanation will be omitted. Note that, while not shown, in the optical fiber cable network group 700, a third optical fiber cable network and a fourth optical fiber cable network can be set, a relay use optical fiber cable 711 can be further extended, and relay use optical fiber cores 775c and 775d can be connected to the third optical fiber cable network and the fourth optical fiber cable network to transmit an optical signal.

In the embodiment which is shown in FIG. 6 or FIG. 7, by setting a plurality of optical fiber cable networks which have first distributors and second distributors and connecting the optical fiber cable networks and the optical transmitter 60 using the relay use optical fiber cores, the optical fiber cable networks can be constructed by optical fiber cables which have optical fiber cores corresponding to the number of drop use closures set. It is sufficient to lay a single relay use optical fiber core from the optical transmitter to the optical fiber cable networks, so the design of the optical fiber cable networks and optical fiber cable network group and core management become easy. Further, by connecting a large number of optical fiber cable networks of the same specifications to construct an optical fiber cable network group, it is possible to lower the unit cost of the optical fiber cable networks and possible to lower the cost of construction compared with the case of constructing a single large optical fiber cable network.

Above, figures were used to explain the optical fiber cable network of the present embodiment. The optical fiber cable network of the present embodiment provides the optical signal device at the terminating end closure as well and enables transmission of an optical signal from the terminating end side of the optical fiber cable as well to enable the effective utilization of the optical fiber cores. Further, it is possible to use an optical fiber cable which has a smaller number of optical fiber cores than the number of optical fiber cores of a conventional optical fiber cable network and the installation costs can be reduced. Further, optical fiber cables of the same number of cores from the starting end closure to the terminating end closure are used, so design of the optical fiber cable network and core management become easy. Further, since optical fiber cables with different numbers of cores are not connected, the connection work is also lightened.

Typical embodiments were used to explain the present invention, but it will be understood that a person skilled in the art could make the above-mentioned changes and various other changes, deletions, and additions without departing from the scope of the present invention.

1. An optical fiber cable comprising:
an optical fiber cable which has a plurality of optical fiber cores which transmit an optical signal,
an optical signal device which is connected to the two ends of at least one optical fiber core in said plurality of optical fiber cores, and
two branchers which are provided at said at least one optical fiber core and which branch the optical signal,
where, among said two branchers, one brancher branches the optical signal from said optical signal device at one end side while the other brancher branches the optical signal from said optical signal device at the other end side.

2. The optical fiber cable network according to claim 1 wherein
said network is further provided with
branch optical fiber cables which are dropped from said plurality of optical fiber cores of said optical fiber cable and
a plurality of optical receivers which connect with said branch optical fiber cables and receive optical signals,
each said optical signal device is provided with
an optical transmitter which transmits an optical signal,
a first distributor which connects said optical transmitter with one end of said optical fiber cable and distributes an optical signal which is transmitted from said optical transmitter to said plurality of optical fiber cores, and
a second distributor at the other end of said optical fiber cable which is connected to said plurality of optical fiber cores so as to distribute an optical signal which is transmitted from at least one optical fiber core among said plurality of optical fiber cores to the other optical fiber cores, and
each of said other optical fiber cores has said one brancher and said other brancher, and said one brancher and said other brancher are connected to said branch optical fiber cables.

3. A method of construction of an optical fiber cable network comprising:
laying an optical fiber cable which has a plurality of optical fiber cores which transmit an optical signal,
connecting, to one end of said optical fiber cable, a first distributor which distributes an optical signal to said plurality of optical fiber cores and connecting, to the other end of said optical fiber cable, a second distributor which distributes an optical signal which is transmitted from at least one optical fiber core among said plurality of optical fiber cores to other optical fiber cores,
providing each of said other optical fiber cores with two branchers which branch optical signals, and
connecting an optical transmitter which transmits an optical signal to said first distributor,
among said two branchers, one brancher branching an optical signal from said first distributor and the other brancher branching an optical signal from said second distributor.

4. The method of construction of an optical fiber cable network as set forth in claim 3, further comprising:
setting an optical receiver which receives the optical signal,
laying a branch optical fiber cable which branches from said plurality of optical fiber cores of said optical fiber cable,
connecting said branch optical fiber cable to said optical receiver and one of said branchers which are connected to the other optical fiber cores.

5. An optical fiber cable network group which is provided with a plurality of optical fiber cable networks as set forth in claim 1, in the optical fiber cable network group, at least one optical fiber cable network among the plurality of optical fiber cable networks provided with an optical fiber cable which transmits an optical signal to the optical signal devices of the other optical fiber cable networks.

6. An optical fiber cable network group which is provided with a plurality of optical fiber cable networks as set forth in claim 1, the optical fiber cable network group provided with optical fiber cables which individually connect to optical signal devices of said plurality of optical fiber cable networks and which have relay use optical fiber cores which transmit optical signals.
